(19) United States
(12) Patent Application Publication
(10) Pub. No.: US 2003/0031014 A1
(43) Pub. Date: Feb. 13, 2003

(54) Rope light structure

(76) Inventor: Tzu-Chen LIU, Taipei (TW)

Correspondence Address: Tzu-Chen LIU, P.O. Box No.6-57, Chung-Ho City, Taipei Hsien 235, R.O.C, TW

(21) Appl. No.: 09/927,378

(22) Filed: Aug. 13, 2001

(51) Int. Cl. F21V 33/00

(52) U.S. Cl. 362/234

(57) ABSTRACT

The present invention relates to a rope light structure, more particularly, one in which the in the middle area occupied by the core wiring there exists a plurality of cavities, and into the said cavities are inserted two sets of series light bulb sets, to be activated by the use of a controlling device; wherein the said structure is able to reduce labor time and material costs, increase the brightness of the light source, prevent the possibility of electrical shortages occurring through bending, so that safety and convenient usage is provided for, thereby effectively increasing economy of use, safety, and usefulness.

### BACKGROUND OF THE INVENTION

1. Field of the Invention

The present invention is a rope light structure, which, more particularly, saves rope light production labor time, saves material costs, increases the brightness of the light source of the rope light, and by eliminating the possibility of electrical shortages occurring during the times the rope light is bent, ensures the safety of its electrical parts. Moreover, by increasing the economy of use and safety of the present invention, safer and more convenient usage is ensured.

2. Description of the Prior Art

There are two design structures existing in respect to a conventional rope light, one of these being one in which a plurality of light bulbs are connected in series to form a plurality of series light bulb sets, and the said sets are further connected in parallel connecting negative and positive terminal poles. As can be seen in FIG. 1, the other type of structure makes use of a single wire, crisscrossing type circuit (it contains three power source wires, one with a positive terminal pole, and two with negative terminal poles), and divides into A, B series-connected light bulb sets 11, 12, wherein, A series-connected light bulb set 11 comprises one positive terminal pole (A electric wire 14) and a negative terminal pole (B electric wire 16) that connect together, so that by operating a controlling device (not shown in drawing) the two sets of series-connected light bulbs can be activated together. In order to prevent lead wires 111, 121, from coming into contact and thus producing an electrical shortage, an isolating electrical wire 13 is inserted in the space between the sets of series-connected light bulbs 11 and 12. However, not only does the structure described in the previous sentence require higher material costs to produce; if the rope light is bent during the construction process, its possible that the lead wires 111, and 121 could come into contact, thus producing an electrical shortage.

After taking into consideration the shortcomings and inconveniences of conventional rope lights, the inventors of the present invention set about researching the possibilities of new innovative design with a determination to arrive at the best possible solution, and by making use of their professional knowledge and judgement, were able to arrive at a design for a rope light structure that is useful, suitable for a wide variety of applications, and useful and economic from the point of view of industry.

### SUMMARY OF THE INVENTION

The primary characteristic of the present invention is: a plurality of cavities in the center area occupied by the core wiring, cavities which are made to an appropiate size, are made, and two sets of series light bulb sets are inserted into core wire cavities, and then a positive terminal pole (A power source wire) and a negative terminal pole of the two sets of series light bulbs are connected together. By the means of operating a controlling device (not shown in drawing), the two sets of series light bulbs are activated. In this way, labor time and material costs are saved, the brightness of the light source is increased, and by preventing the possibility of an electrical shortage produced by a bending of the rope light, the safety of its electronic parts is ensured, so that safe and convenient usage is provided, thereby effectively increasing economy of use, safety, and usefulness.

The primary objective of the present invention is to insert two sets of series light bulbs into core wire cavities lying in the space separating the two sets of series light bulbs, and in this way save on labor time and material costs, increase the brightness of the light source, prevent the possibility of an electrical shortage caused by bending, ensure the safety of its electronic parts, so that safe and convenient usage is provided, and thereby effectively increasing economy of use, safety, and usefulness.

In order for the examiner to better understand the objectives, characteristics, and functions of the present invention, a detailed description of the preferred embodiments along with accompanying illustrations has been provided.

### BRIEF DESCRIPTION OF THE DRAWINGS

FIG. 1 is a cross-sectional sideways-view of a conventional rope light

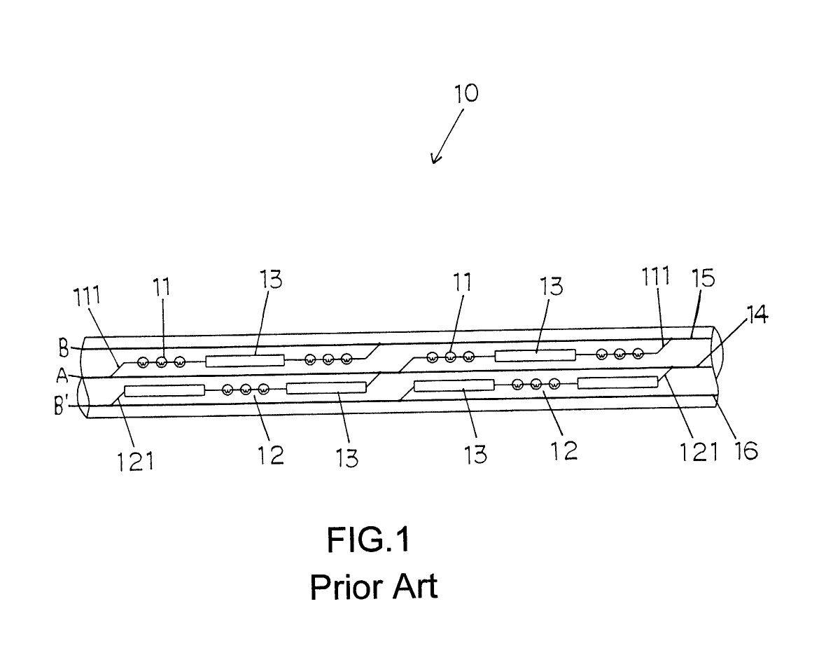

FIG. 2 is a cross-sectional sideways-view of the present invention.

FIG. 3 is a cross-sectional view from above of the present invention.

### DETAILED DESCRIPTION OF THE PREFERRED EMBODIMENTS

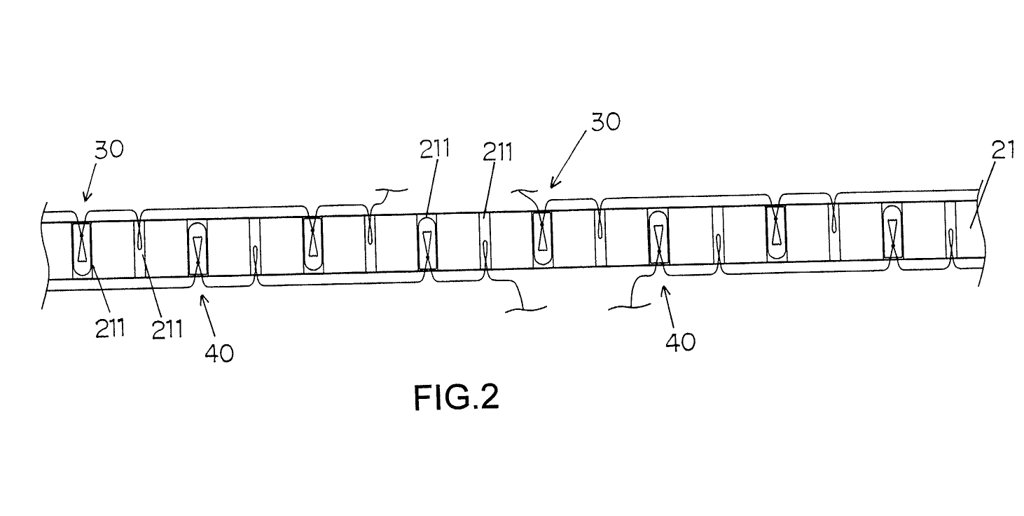

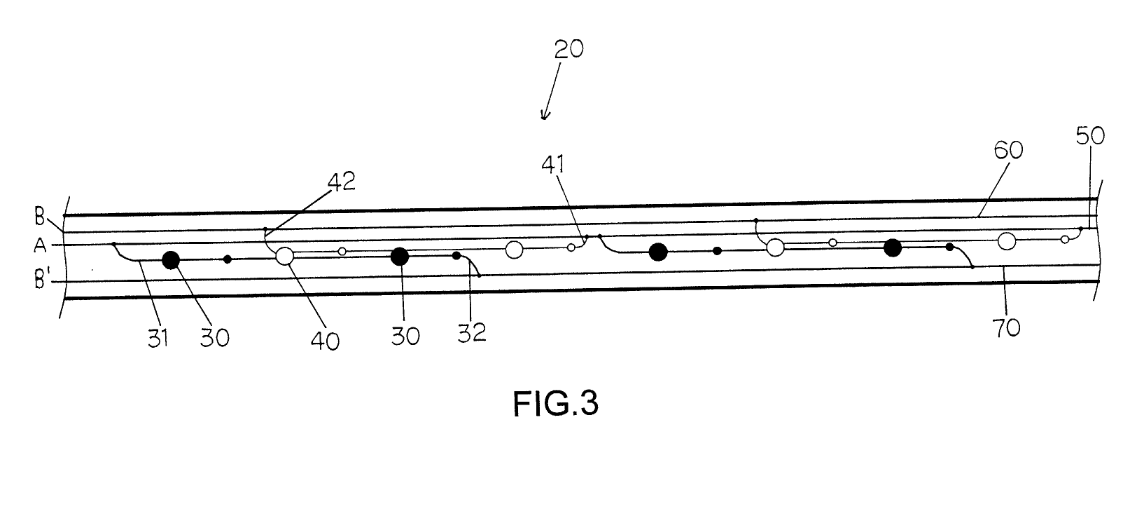

Referring to FIGS. 2 and 3, cross sectional side view and cross-sectional view drawings of the present invention. The present invention rope light structure 20, is organized into a circuit consisting of single zigzagging lines, (there are three power source wires, one A power source wire 50 positive terminal pole, and two, B power source wire 60 and B′ power source wire 70, negative terminal ends); a flexible core wiring 21 is covered over by surrounding piping, and core wiring 21 comprises, A and B, two sets of series light bulbs, so that the structure is ordered as follows:

There exists a plurality of cavities 211 located in the core wire area 21, cavities that are made to an appropiate size, wherein, the light bulbs of A set series light bulb set 30 are inserted into the plurality of cavities 211 from above, and the light bulbs of B set series light bulb set 40 are inserted into the plurality of cavities from below, wherein, lead wire 31 of A set series light bulb set is connected with the positive terminal pole of power source wire 50, and one other lead wire 32 is connected to negative terminal pole B′ of power source wire 70. Moreover, lead wire 42 of B set series light bulb set 40 is connected to the negative terminal pole B of power source wire 60, the controlling device of the prior art (not shown in drawing) is then used to activate series light bulb sets 30 and 40.

In accordance with the description above, the series light bulb sets are inserted into the core wire cavity in the area lying between the series light bulb sets of the present invention, and in this way save labor time, save labor costs, increase the brightness of the light source, and by reducing the possibility of an electrical shortage occurring as a result of bending the present invention, ensure the safety of its electrical parts, so that safety and convenient usage is provided, thereby effectively increasing economy of use, safety, and usefulness.

To extend the description given in the above paragraph, the claims of the present invention are as follows:

Because the present invention does not make use of the isolating wire used by conventional rope lights, the brightness of its light source is subsequently increased.

The area in which the power source or electrical conductor of the present invention is located is extremely large, and the isolating characteristics of the present invention are of a high quality, so that if it is bent at an extreme angle, an electrical shortage won't occur as a result, thus increasing the degree of safety and convenience of use of the present invention.

Because the two series light bulb sets of the present invention are inserted into the core wiring cavity lying between the two sets of series light bulb sets, both labor time and material costs are reduced.

To summarize the proceeding points, the structure of the present invention, a rope light, is more practical, useful, and economical than conventional rope lights, and as such represents an improvement on such structures as well as being an excellent design in its own rights, and, moreover, is fully in accordance with the legal requirements of patents, this being so, a legal request for patent rights is hereby made, with the polite request that the inspection be carried out as quickly as possible so that permission may be granted quickly.

The written and visual descriptions of the of present invention contained herein, represent only a basic definition of the present invention, and cannot be used to limit the scope of the practical uses to which it can be put; the description and claim made in respect to the structure, characteristics, and functions of the present invention are thus subject to change, and the said right is included as part of the patent rights.

1. A rope light structure with a single wire crisscrossing type circuit, comprising three power source wires, one a power source wire negative terminal pole, two other, b power source wire, and b power source wire, negative terminal ends, wherein, flexible core wiring is installed in piping, flexible wiring that comprises a plurality of series light bulb sets, and characterized in that:in the middle of the area occupied by the core wiring there exists a plurality of cavities, wherein, two sets of series light bulb sets are inserted into the said cavities, and the said series light bulb sets are activated via the use of a controlling device existing in the prior art.
